(19) United States
(12) Patent Application Publication
(10) Pub. No.: US 2026/0111663 A1
(43) Pub. Date: Apr. 23, 2026

(54) Call-Center Script Reconstruction and Recovery

(71) Applicant: American TEL-A-Systems, Inc., McFarland, WI (US)

(72) Inventors: Thomas V. Curtin, Madison, WI (US); Kevin Mark Beale, Stoughton, WI (US); Daniel R. Cropp, McFarland, WI (US); Paul L. Hansen, McFarland, WI (US); Wayne Paul Waldner, Richland Center, WI (US); Christopher Richard Bach, Madison, WI (US)

(21) Appl. No.: 18/924,687

(22) Filed: Oct. 23, 2024

(51) Int. Cl. G06F 40/205; H04M 3/51

(52) U.S. Cl. CPC G06F 40/205; H04M 3/5175; H04M 2203/301

(57) ABSTRACT

This disclosure relates to a system and method for call-center script reconstruction and recovery where an applications server is communicatively coupled to an analytics engine. The applications server receives a plurality of actual call flows using a shared baseline script and sends information about the plurality of actual call flows to the analytics engine. The analytics engine parses the information into a plurality of information segments, determines whether each of the information segments is part of the shared baseline script, and determines an order and branch of the shared baseline script to which each of the information segments belong. The analytics engine recreates the shared baseline script.

### TECHNICAL FIELD

The present disclosure relates, in general, to communication systems and, more particularly, to systems and methods for call center script reconstruction and recovery.

### BACKGROUND

Call-centers are designed to connect callers to agents or other company representatives for a variety of purposes. Business owners may require call-center services to manage incoming calls, including calls from prospective and existing customers. Customer experiences with call-centers are important to the success of a business. For example, if a prospective customer encounters difficulty being connected to the sales team, the business owner may lose a sale. For at least this reason, the use of scripts for guiding communication sessions (e.g., calls or webchats) between an agent and a caller are important to the success of the call-center, as it allows clients of the call-center to ensure the quality and consistency of the customer experience.

Intelligent scripts are one kind of call-center script that may guide call-center agents through call completion steps dependent on a customer's responses during a call. Due in part to their potential to branch and present complex information responsive to a call flow, creating intelligent scripts can be both time-consuming and challenging.

After investing significant time and/or resources into the development of scripts, businesses may lose access to their scripts for a variety of reasons. For example, a business may want to change call-center providers but software differences between the providers may cause scripts used with a prior provider to be incompatible with the new provider's systems. As another example, a business may desire to upgrade from a legacy call center system to a new call center system—once again leading to scripts which are incompatible between the two systems. As yet another example, a business may lose their existing scripts to data corruption and/or deletion. Existing approaches to mitigating this problem are deficient. At present, existing systems lack the capability to address the issues with incompatibility among script types. Thus, the process of migrating to a new call center system can be very time consuming and labor intensive. Another problem with existing approaches is that they often introduce inaccuracies to the scripts. Accordingly, there is a need for systems and methods to address these problems.

Besides the scripts themselves, an agent's performance using a script is also important. For example, if an agent fails to collect required information during a call, downstream processes may suffer. As another example, poor agent performance may result directly in customer dissatisfaction. Conversely, well performing agents may directly contribute to customer satisfaction.

However, existing techniques for evaluating call center agent performance suffer from significant disadvantages. One problem with existing approaches is that they are not tailored to a specific script or scaled against typical agent performance. Some aspects of agent performance may be more or less important depending on the specific script used by the agent. Thus, there is also a need for improved systems and methods for agent evaluation.

### SUMMARY OF EXAMPLE EMBODIMENTS

According to embodiments of the present disclosure, the above-described disadvantages associated with existing solutions may be reduced or eliminated.

In accordance with a particular embodiment of the present disclosure, a system includes an applications server communicatively coupled to an analytics engine. The applications server may be configured to receive a plurality of actual call flows. Each of the plurality of actual call flows may be associated with a respective communication session. Each of the respective communication sessions may use a shared baseline script. The system may also include an analytics engine. The applications server may be configured to send information about the plurality of actual call flows to the analytics engine. The analytics engine may be configured to analyze the information about the plurality of actual call flows by parsing the information into a plurality of information segments. The analytics engine may further be configured to determine whether each of the information segments is part of the shared baseline script, and, for the information segments determined to be part of the shared baseline script, determine an order and branch of the shared baseline script to which each of the information segments belong. The analytics engine may further be configured to recreate, using the analysis, the shared baseline script.

In some embodiments, the plurality of actual call flows may comprise an audio recording of each of the plurality of communication sessions.

In some embodiments, the applications server may be further configured to transcribe the received audio recordings of each of the plurality of communication sessions. The information sent to the analytics engine may comprise a transcription of each audio recording.

In some embodiments, the transcription of each audio recording may use a meta-language and the transcription of the received audio recordings using the meta-language may require less data than a full-text transcription.

In some embodiments, each of the plurality of actual call flows may further comprise metadata and the metadata may include at least one of: a creation date of the audio recording, an identity of a participant of the associated communication session, and a call note made during the associated communication session.

In some embodiments, the plurality of actual call flows may be a first plurality of actual call flows. The shared baseline script may be a first shared baseline script. The applications server may be further configured to receive a second plurality of actual call flows. Each of the second plurality of actual call flows may be associated with a respective communication session. Each of the respective communication sessions may be associated with the second plurality of actual call flows and may use a second shared baseline script. The applications server may further be configured to send information about the second plurality of actual call flows to the analytics engine. The analytics engine may be further configured to analyze the information about the second plurality of actual call flows by parsing the information into the plurality of information segments, determining whether each information segment is part of the second shared baseline script, and, for information segments determined to be part of the second shared baseline script, determining an order and branch of the second shared baseline script to which each of the information segments belong. The analytics engine may further be configured to recreate, based on the analysis of the second plurality of actual call flows, the second shared baseline script.

In some embodiments, the analysis of the information about the first plurality of actual call flows and the analysis of the information about the second plurality of actual call flows may occur concurrently.

In accordance with another aspect of the present disclosure, a method includes receiving a plurality of actual call flows. Each of the plurality of actual call flows may be associated with a respective communication session. Each of the respective communication sessions may use a shared baseline script. The method may further include analyzing information about the plurality of actual call flows by parsing the information into a plurality of information segments, determining whether each of the information segments is part of the shared baseline script, and, for the information segments determined to be part of the shared baseline script, determining an order and branch of the shared baseline script to which each of the information segments belong. The method may further include recreating, using the analysis, the shared baseline script.

In some embodiments, the plurality of actual call flows may comprise an audio recording of each of the plurality of communication sessions.

In some embodiments, the method may further include transcribing the received audio recordings of each of the plurality of communication sessions. The information may comprise a transcription of each audio recording.

In some embodiments, the transcription of each audio recording may use a meta-language. The transcription of the received audio recordings using the meta-language may require less data than a full-text transcription.

In some embodiments, each of the plurality of actual call flows may further comprise metadata. The metadata may include at least one of: a creation date of the audio recording, an identity of a participant of the associated communication session, and a call note made during the associated communication session.

In some embodiments, the plurality of actual call flows may be a first plurality of actual call flows. The shared baseline script may be a first shared baseline script, and the method may further comprise: receiving a second plurality of actual call flows, each of the second plurality of actual call flows may be associated with a respective communication session, each of the respective communication sessions may be associated with the second plurality of actual call flows utilizing a second shared baseline script. The method may further comprise analyzing the information about the second plurality of actual call flows by parsing the information into the plurality of information segments, determining whether each information segment is part of the second shared baseline script, and, for information segments determined to be part of the second shared baseline script, determining an order and branch of the second shared baseline script to which each of the information segments belong. The method may further comprise recreating, based on the analysis of the second plurality of actual call flows, the second shared baseline script.

In some embodiments, the analysis of the information about the first plurality of actual call flows and the analysis of the information about the second plurality of actual call flows may occur concurrently.

In accordance with another aspect of the present disclosure, a non-transitory computer readable medium may have stored therein a program which, when executed by a processor, causes the processor to perform a method. The method may comprise receiving a plurality of actual call flows, each of the plurality of actual call flows associated with a respective communication session. Each of the respective communication sessions may use a shared baseline script. The method may further comprise analyzing the information about the plurality of actual call flows by parsing the information into a plurality of information segments, determining whether each of the information segments is part of the shared baseline script, and, for the information segments determined to be part of the shared baseline script, determining an order and branch of the shared baseline script to which each of the information segments belong. The method may further comprise recreating, using the analysis, the shared baseline script.

In some embodiments, the plurality of actual call flows may comprise an audio recording of each of the plurality of communication sessions.

In some embodiments, the program may be further configured when executed to transcribe the received audio recordings of each of the plurality of communication sessions and the information may comprise a transcription of each audio recording.

In some embodiments, the transcription of each audio recording may use a meta-language and the transcription of the received audio recordings using the meta-language may require less data than a full-text transcription.

In some embodiments, each of the plurality of actual call flows may further comprise metadata and the metadata may include at least one of: a creation date of the audio recording, an identity of a participant of the associated communication session, and a call note made during the associated communication session.

In some embodiments, the plurality of actual call flows may be a first plurality of actual call flows, the shared baseline script may be a first shared baseline script, and the program may be further configured when executed to receive a second plurality of actual call flows. Each of the second plurality of actual call flows may be associated with a respective communication session. Each of the respective communication sessions associated with the second plurality of actual call flows may use a second shared baseline script. The program may further be configured when executed to analyze the information about the second plurality of actual call flows by parsing the information into plurality of information segments, determining whether each information segment is part of the second shared baseline script, and, for information segments determined to be part of the second shared baseline script, determining an order and branch of the second shared baseline script to which each of the information segments belongs. The program may further be configured when executed to recreate, based on the analysis of the second plurality of actual call flows, the second shared baseline script and the analysis of the information about the first plurality of actual call flows and the analysis of the information about the second plurality of actual call flows may occur concurrently.

Certain embodiments of the present disclosure may provide one or more technical advantages. As one example, certain embodiments advantageously offer the ability to reconstruct and thereby recover one or more baseline scripts. As another example, in certain embodiments, a plurality of actual call flows may be transcribed into a meta-language before further processing which may advantageously use less memory and processing power than using full-text transcriptions. As another example, an artificial intelligence model according to certain embodiments is trained using call-center scripts. This may advantageously improve the operation of an analytics engine to accurately reconstruct and/or recover scripts. Allowing for script reconstruction and/or recovery may also advantageously act as a “backup” for the scripts without requiring any additional storage beyond that already used during normal operation of a call-center.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a block diagram of an example communication system, in accordance with certain embodiments;

FIG. 2 is a flow diagram of an exemplary method, in accordance with certain embodiments;

FIG. 3 is a flow diagram of an exemplary method, in accordance with certain embodiments.

FIG. 4 is a flow diagram of an exemplary method, in accordance with certain embodiments.

### DETAILED DESCRIPTION

As described above, existing systems for call-center script reconstruction and recovery suffer from several significant deficiencies and inefficiencies. For example, existing systems are time consuming and have the potential to introduce error to the script recreation process. As another example, existing systems fail to provide a way to adequately evaluate agents tailored to a specific script. The present disclosure contemplates various embodiments that may address these and other deficiencies associated with existing approaches.

For example, in some aspects, the present disclosure relates to a system, the system including: an applications server communicatively coupled to an analytics engine, wherein: the applications server is configured to: receive a plurality of actual call flows, each of the plurality of actual call flows associated with a respective communication session, each of the respective communication sessions utilizing a shared baseline script; and send information about the plurality of actual call flows to the analytics engine; and the analytics engine is configured to: analyze the information about the plurality of actual call flows by parsing the information into a plurality of information segments, determining whether each of the information segments is part of the shared baseline script, and, for the information segments determined to be part of the shared baseline script, determining an order and branch of the shared baseline script to which each of the information segments belong; and recreate, using the analysis, the shared baseline script.

In some aspects, the present disclosure relates to a method, the method including: receiving a plurality of actual call flows, each of the plurality of actual call flows associated with a respective communication session, each of the respective communication sessions utilizing a shared baseline script; analyzing information about the plurality of actual call flows by parsing the information into a plurality of information segments, determining whether each of the information segments is part of the shared baseline script, and, for the information segments determined to be part of the shared baseline script, determining an order and branch of the shared baseline script to which each of the information segments belong; and recreating, using the analysis, the shared baseline script.

In some aspects, the present disclosure relates to a non-transitory computer readable medium which may have stored therein a program, the program configured when executed to: receive a plurality of actual call flows, each of the plurality of actual call flows associated with a respective communication session, each of the respective communication sessions utilizing a shared baseline script; analyze the information about the plurality of actual call flows by parsing the information into a plurality of information segments, determining whether each of the information segments is part of the shared baseline script, and, for the information segments determined to be part of the shared baseline script, determining an order and branch of the shared baseline script to which each of the information segments belong; and recreate, using the analysis, the shared baseline script.

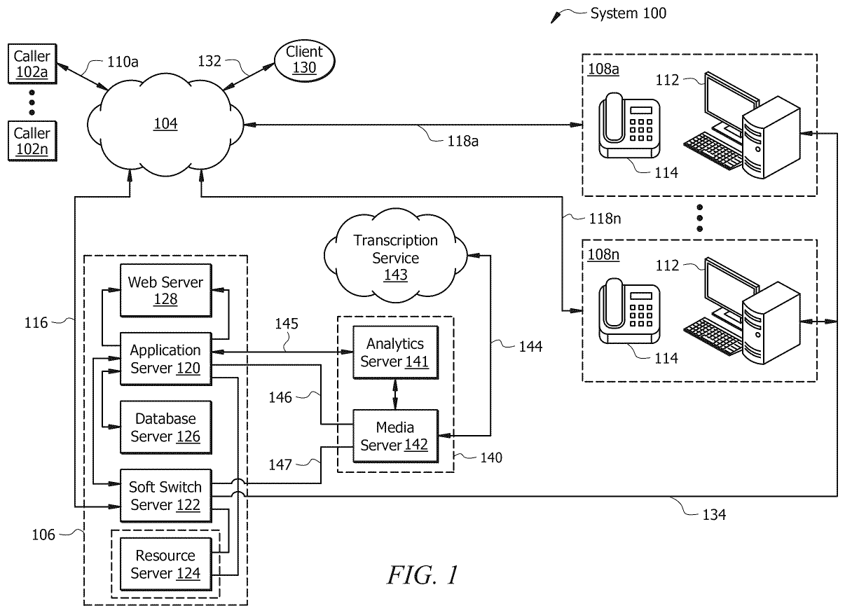

Embodiments of the present disclosure and its advantages may be understood by referring to FIGS. 1, 2, 3, and 4 with like numerals being used for like and corresponding parts of the various drawings.

FIG. 1 is a block diagram of an example communication system 100, in accordance with certain embodiments. More particularly, FIG. 1 illustrates communication system 100 comprising one or more callers 102a-102n, a service platform 106, analytics engine 140, one or more operator stations 108a-108n, and client 130. Although FIG. 1 illustrates one example of communication system 100, it should be understood that this is for purposes of example only and the present disclosure is not limited to the example communication system of FIG. 1. Rather, the present disclosure contemplates that other embodiments of system 100 may be used without departing from the scope of the present disclosure.

In the example embodiment of FIG. 1, callers 102a-102n, service platform 106, analytics engine 140, and client 130 are coupled between each other and network 104 through various communication links. As used throughout this document, the term “couple” and/or “coupled” refers to any direct or indirect communication between two or more elements, whether those elements are in physical contact with one another. For example, client 130 may use any computing and/or communication device capable of enabling the communication of information to or from one or more of caller 102, service platform 106, client 130, and analytics engine 140 over network 104.

Network 104 may comprise any wireless network, wireline network, or combination of wireless and wireline networks capable of supporting communication between network elements using ground-based and/or space-based components. For example, network 104 may comprise a data network, a public switched telephone network (PSTN), an integrated services digital network (ISDN), a local area network (LAN), a wide area network (WAN), a metropolitan area network (MAN), all or a portion of the global computer network known as the Internet, and/or other communication systems or combination of communication systems at one or more locations.

Service platform 106 receives and/or communicates data (e.g., from or to callers 102a-102n, operator stations 108, and/or from or to client 130) through network 104 coupled to service platform 106. In the example of FIG. 1, service platform 106 couples to network 104 through communications link 116. In certain embodiments, service platform 106 operates to collect, store, and/or communicate data to and/or from network 104. In certain embodiments, service platform 106 may be configured to integrate with, for example, telephone carriers and private branch exchange (PBX) equipment to provide a stand-alone, fully functional call-center environment. In some cases, the carrier and PBX integration may be established using a Session Initiation Protocol (SIP) trunk integration method. In operation, service platform 106 may provide a full suite of call-center and enterprise functionality. The various elements of service platform 106 and exemplary functionality of service platform 106 are described in more detail below.

In the example embodiment of FIG. 1, system 100 also includes a plurality of operator stations 108a through 108n. Operator stations 108a through 108n are coupled to service platform 106 through communications link 134. Operator stations 108 are capable of receiving, collecting, storing, and/or communicating data to and/or from network 104. In the example embodiment of FIG. 1, operator stations 108a through 108n are coupled to network 104 through communications links 118a and 118n, respectively.

In certain embodiments, operator stations 108a through 108n may be in a call-center. For example, each operator station 108 may be a live agent-based data collection system capable of collecting data from, for example, caller 102 or client 130. Although operator station 108 is an agent-based system in the example embodiment of FIG. 1, the present disclosure contemplates that other suitable data collection systems may be used without departing from the scope of the present disclosure.

As used herein, the term agent should be interpreted broadly to encompass any individual that a caller may be connected to. As non-limiting examples, an agent may refer to an agent working in a call-center (e.g., at one of operator stations 108), an employee of an organization associated with service platform 106, a technician (that may or may not be working remotely from a call-center), speech-enabled intelligent script, or any other suitable person or entity. Although certain embodiments may describe an agent as an operator associated with a call-center, the present disclosure is not limited to such an example embodiment. Rather, the various embodiments described herein may be applied to other suitable scenarios, such as those not involving a traditional call-center (having a plurality of operator stations in one, centralized location) or any scenario involving communication using scripts. For example, in certain embodiments agents may be distributed geographically and may couple to service platform 106 via one or more different networks.

Although referred to herein as a caller, callers 102a-102n are not limited to individuals or devices that initiate a telephone call. Rather, the present disclosure contemplates that callers 102a-102n may engage in a variety of types of communication sessions (e.g., telephone calls, video conferencing, text message, or web chat). It should also be understood that a caller 102 is not limited to a party initiating a communication session. For example, callers 102a-102n may be a calling party or a called party that communicates and/or receives data to and/or from service platform 106. Each caller 102 may use, for example, a telephone (e.g., a wireline telephone), a wireless device (e.g., a smartphone), a voice over Internet Protocol (IP) device, a desktop computer, a laptop computer, a personal digital assistant (PDA), a workstation, a mainframe computer, a mini-frame computer, a web server, or any other computing and/or communicating device.

Operator stations 108 may comprise any suitable computing and/or communicating device or combination of devices. In the example embodiment of FIG. 1, each operator station 108 includes a host 112 and a communication device 114. Communication device 114 enables an agent to communicate with caller 102. Communication device 114 may comprise, for example, a telephone, a wireless device, a voice over IP device, or any other computing and/or communicating device or combination of devices. Although the example embodiment of FIG. 1 illustrates host 112 and communication device 114 as separate devices, one device that is capable of performing the desired functionality could be used without departing from the scope of the present disclosure. Host 112 may comprise, for example, a desktop computer, a laptop computer, a server computer, a personal digital assistant, and/or any other computing or communicating device or combination of devices. In certain embodiments, host 112 may be connected to a PBX-based automated call distribution (ACD) or an ACD of service platform 106. Host 112 may be configured to run software, such as a soft agent. The soft agent may, for example, include a SIP-based soft phone and switch-specific computer telephony integration (CTI) control of the agent state during call handling. The soft agent may provide an interface to service platform 106, and in particular to applications server 120 and softswitch server 122 of service platform 106. Host 112 may include a graphical user interface (GUI) that enables a live agent to collect, enter, process, store, retrieve, display, amend, and/or dispatch data during the interaction of operator station 108 with a user of caller 102 or client 130 (e.g., during a call). Host 112 may run console software that provides, for example, IP-based call handling using the GUI and, for example, an input device (such as a mouse, keyboard, microphone, or other suitable input device).

Client 130 may be business or other entity that has engaged a call-center to manage incoming and/or outgoing calls. In the example of FIG. 1, caller 102 is coupled to network 104 through communication link 110a and client 130 is coupled to network 104 through communications link 132. Like the caller 102 described above, client 130 may use any computing and/or communication device capable of enabling the communication of information to or from service platform 106 over network 104. For example, client 130 may use a telephone (e.g., a wireline telephone), a wireless device (e.g., a smartphone), a voice over IP device, a desktop computer, a laptop computer, a PDA, a workstation, a mainframe computer, a mini-frame computer, a web server, or any other computing and/or communicating device.

As noted above, in the example embodiment of FIG. 1 service platform 106, analytics engine 140, and client 130 are coupled to network 104 through various communication links. More particularly, communication system 100 includes communication links 110a, 116, 118, 132, and 134 operable to facilitate the communication of data to and/or from network 104. Likewise, communication system 100 includes communication links 144, 145, 146, and 147, each operable to facilitate the communication of data to and/or from analytics engine 140. Communication links 110a, 116, 118, 132, 134, 144, 145, 146, and 147 may include any hardware, software, firmware, or combination thereof. In various embodiments, communication links 110a, 116, 118, 132, 134, 144, 145, 146, and 147 may comprise communications media capable of assisting in the communication of analog and/or digital signals. Communication links 110a, 116, 118, 132, 134, 144, 145, 146, and 147 may, for example, comprise a twisted-pair copper telephone line, a fiber optic line, a Digital Subscriber Line (DSL), a wireless link, a USB bus, a PCI bus, an ethernet interface, or any other suitable interface operable to assist in the communication of information.

Data may be transmitted over communication links 110a, 116, 118, 132, 134, 144, 145, 146, and 147 using any suitable protocol. As non-limiting examples, protocols such as the Real-time Transport Protocol (RTP) and WebRTC may be used. RTP is a network protocol for delivering audio and video over IP networks via streaming. WebRTC is an open framework for the web that enables high quality real-time communication sessions over a network. WebRTC allows for the streaming of audio and/or video media without requiring an intermediary or third-party software.

As noted above, service platform 106 may provide a full suite of call-center and enterprise functionality. Service platform 106 may comprise any suitable combination of hardware, software, and/or firmware. In certain embodiments, service platform 106 may comprise any device or combination of devices that may include one or more software and/or firmware modules. In the example embodiment of FIG. 1, service platform 106 includes an applications server 120, a softswitch server 122, a resource server 124, a database server 126, and a web server 128. Although FIG. 1 illustrates a particular arrangement of elements of service platform 106, it should be understood that the present disclosure is not limited to the precise arrangement of the example embodiment of FIG. 1. For example, although FIG. 1 illustrates an example embodiment in which applications server 120, softswitch server 122, resource server 124, database server 126, and web server 128 are incorporated into a single device, the present disclosure is not limited to this example embodiment. In certain embodiments, the elements of service platform 106 may be distributed. In certain embodiments, service platform 106 may contain fewer components than those illustrated in the example embodiment of FIG. 1. For example, in certain embodiments, the functions of resource server 124 may be performed by media server 142, explained in greater detail below with respect to analytics engine 140. Additionally, in certain embodiments, service platform 106 may contain any suitable additional components that may provide one or more of the functionalities described herein and/or additional functionality to service platform 106.

Applications server 120 may house one or more applications used by service platform 106. In certain embodiments, applications server 120 may provide a full suite of call-center and enterprise applications. Exemplary call-center and enterprise applications provided by applications server 120 are described below.

Softswitch server 122 is coupled to applications server 120 and resource server 124 in the example embodiment of FIG. 1. Softswitch server 122 may house the switching components of service platform 106. For example, softswitch server 122 may include a softswitch. In certain embodiments, the softswitch may be a SIP-based telephony switch. The softswitch may receive inbound phone calls and send outgoing call requests. The softswitch may provide telephony services to, for example, IP subscribers and traditional PSTN subscribers, for example by supplying the trunking between the IP and PSTN networks. Softswitch server 122 may operate in tandem with one or more of applications server 120, resource server 124, database server 126, web server 128, and media server 142 to provide voice processing and switching resources. For example, softswitch server 122 may provide one or more of intelligent call routing, switch-based configurable call control, multi-lingual voice processing resources, and other suitable functionality. In certain embodiments, softswitch server 122 may stream audio or video to media server 142 for processing (for example, using the speech recognition functionality of media server 142, described in more detail below).

In the example embodiment of FIG. 1, resource server 124 is coupled to applications server 120 and softswitch server 122. In certain embodiments, resource server 124 may operate in tandem with one or more of applications server 120, softswitch server 122, database server 126, and web server 128 to provide voice processing resources for service platform 106. For example, resource server 124 may provide a speech recognition engine and voice resources for service platform 106. Resource server 124 may include an automatic speech recognition (ASR) engine capable of processing voice responses, natural language processing, text-to-speech translations, and/or speech-to-text translations in connection with one or more voice-enabled functions of service platform 106. In certain embodiments, resource server 124 can be configured to use one or more customizable grammars to match spoken phrases to, for example, directory listings. Resource server 124 may be configured to receive audio from softswitch server 122 for processing using the speech-recognition functionalities described above. In certain embodiments, some or all the functionality described above as performed by resource server 124 may be performed by media server 142.

Database server 126 is coupled to applications server 120. Database server 126 may store information utilized by one or more other elements of service platform 106 (such as applications server 120, softswitch server 122, resource server 124, and web server 128) or analytics engine 140 (such as analytics server 141 and media server 142). For example, database server 126 may store one or more of recorded audio, video, transcripts of communication sessions, speech recognition patterns, and any other suitable information. In certain embodiments, database server 126 may use an SQL server database engine for database management, storage, and retrieval. Database server 126 may include memory capable of storing data. The memory may include any hardware, software, firmware, or combination thereof operable to store and facilitate retrieval of information. The memory may store information using any of a variety of data structures, arrangements, and/or compilations. The memory may, for example, include a dynamic random-access memory (DRAM), a static random-access memory (SRAM), a NAND flash memory, and/or any other suitable volatile or nonvolatile storage and retrieval device or combination of devices.

Data stored in database server 126 may be accessible by multiple components of service platform 106. For example, the data stored in database server 126 may be accessible to one or more of applications server 120, softswitch server 122, resource server 124, and web server 128. Storing data in a memory that is accessible to multiple elements of communication system 100 can prove advantageous when it is desired to subsequently access and process this information. In certain embodiments, analytics server 141 and/or media server 142 may directly and/or indirectly (e.g., via applications server 120) access the data stored in database server 126.

Web server 128 provides the web services for service platform 106. In certain embodiments, web server 128 may provide access to the data stored in database server 126 (e.g., directly and/or indirectly). In certain embodiments, web server 128 may provide direct access to the data stored in database server 126. In certain embodiments, web server 128 may provide indirect access to database server 126 (e.g., through applications server 120). In certain embodiments, web server 128 may provide direct access to the information stored in analytics server 141. In certain embodiments, web server 128 may provide indirect access to the information stored in analytics server 141 (e.g., through applications server 120). Web server 128 may provide administrative, monitoring, and reporting tools for the information stored in the database server 126 and/or analytics server 141.

In certain embodiments, service platform 106 may include all or some suitable combination of the servers described above, as well as (alternatively or in addition to) other elements configured to perform desired communicating and/or computing functionality.

Each of applications server 120, softswitch server 122, resource server 124, database server 126, and web server 128 may comprise any suitable combination of hardware, software, and firmware. In certain embodiments, one or more of applications server 120, softswitch server 122, resource server 124, database server 126, and web server 128 may include processing circuitry, such as a combination of one or more of a controller, microprocessor, microcontroller, central processing unit, digital signal processor, application-specific integrated circuit, field programmable gate array, or any other suitable computing device, resource, or combination of hardware, software, and/or encoded logic operable to provide the functionality described herein. The processing circuitry may execute instructions stored in device readable medium or in memory to provide the functionality described herein. Applications server 120, softswitch server 122, resource server 124, database server 126, and web server 128 may comprise any form of volatile or non-volatile computer readable memory including, for example, persistent storage, solid-state memory, remotely mounted memory, magnetic media, optical media, random access memory (RAM), read-only memory (ROM), mass storage media (for example, a hard disk), removable storage media (e.g., a flash drive, a Compact Disk (CD) or a Digital Video Disk (DVD)), and/or any other volatile, non-transitory device readable and/or computer executable memory devices that store information, data, and/or instructions that may be used by the processing circuitry. The memory may store any suitable instructions, data, or information, including a computer program, software, an application including one or more of logic, rules, code, tables, etc. and/or other instructions capable of being executed by the processing circuitry to perform the various functionalities described herein. In some cases, the processing circuitry and device readable medium may be considered to be integrated.

In certain embodiments, one or more of applications server 120, softswitch server 122, resource server 124, database server 126, and web server 128 may run on dedicated servers. In certain embodiments, one or more of applications server 120, softswitch server 122, resource server 124, database server 126, and web server 128 may run in a virtual server environment. Running applications server 120, softswitch server 122, resource server 124, database server 126, and web server 128 in a virtual server deployment may advantageously reduce the number of servers needed and provide greater flexibility in terms of redundancy and ease of deployment.

In the example embodiment of FIG. 1, analytics engine 140 includes an analytics server 141 and a media server 142. Although FIG. 1 illustrates a particular arrangement of elements of analytics engine 140, it should be understood that the present disclosure is not limited to the precise arrangement of the example embodiment of FIG. 1. For example, although FIG. 1 illustrates an example embodiment in which the analytics server 141 and media server 142 are located in the same device, the present disclosure is not limited to this example embodiment. In certain embodiments, the elements of analytics engine 140 may be distributed. In certain embodiments, analytics engine 140 may contain fewer components than those illustrated in the example embodiment of FIG. 1. Additionally, in certain embodiments, analytics engine 140 may contain any suitable additional components that may provide one or more of the functionalities described herein and/or additional functionality of analytics engine 140. In a preferred embodiment, analytics engine 140 is cloud-based.

As noted above, applications server 120 may house one or more applications used by service platform 106 to provide a full suite of call-center and enterprise applications. For example, applications server 120 may provide various voice services (alone or in combinations with, for example, one or more of softswitch server 122, resource server 124, and media server 142). For instance, applications server 120 may provide call-center functions such as playing greetings to callers 102a-102n with multi-level navigation menus, playing automated call queuing announcements, playing automated agent greetings, automated call recording and playback, and other suitable functions. In certain embodiments, applications server 120 may provide for automated outbound phone calls with messages played using integrated text-to-speech.

In certain embodiments, applications server 120 may provide script recovery and/or reconstruction functionality. As described above, in some situations a client 130 of the call center may be unable to use its pre-existing scripts (e.g., intelligent scripts). In these instances, the client may desire to recover or recreate a script or intelligent script. In some cases, the client 130 may have access to a plurality of transcripts, recordings, and/or other information about actual call flows of a plurality of communication sessions which involved the intelligent script they wish to recover (e.g., previous communication sessions that each used a shared baseline script). In certain embodiments, application server 120 may enable a client 130 to use the information they have about a plurality of actual call flows using the shared baseline script (e.g., recordings, transcripts, or other information) to generate (e.g., recreate, recover, or reconstruct) the shared baseline script into a form usable by the client 130. It should be understood that although certain examples described herein refer to intelligent scripts, the present disclosure is not limited to use with intelligent scripts and could be used with a variety of types of scripts.

In certain embodiments, applications server 120 may be configured to monitor information about actual call flows of a plurality of communications sessions during normal operation of a call center. For example, applications server 120 may monitor a plurality of communication sessions between agents and callers 102a-102n over time. In certain embodiments, monitoring a communication session may comprise creating an audio recording of the communication session. In certain embodiments, monitoring a communication session may comprise creating a text transcript of the communication session. In certain embodiments, monitoring a communication session may comprise generating notes about a communication session. In certain embodiments, monitoring a communication session may comprise generating metadata related to the communications session. In certain embodiments, monitoring a communication session may involve any combination of one or more these activities. In certain embodiments, applications server 120 may store information generated by monitoring a plurality of communication sessions. In certain embodiments, database server 126 may store information generated by monitoring a plurality of communication sessions.

In certain embodiments, application server 120 may obtain information about the actual call flows of a plurality of communication sessions without monitoring the actual call flows of a plurality of communications sessions during normal operation of a call center. For example, in some embodiments information about the actual call flows for a plurality of communication systems may be collected and/or generated by a legacy call-center system. In certain embodiments, the scripts of the call-center system are incompatible but the information about actual call flows of a plurality of communication session may be in a format that may be processed by applications server 120. For example, the information may be in the form of audio recordings of the actual call flows, transcripts of the actual call flows, notes concerning the actual call flows, metadata about the actual call flows, and/or a combination of these forms of information. In certain embodiments, information about the actual call flows of a plurality of communication session is obtained from database server 126. In certain embodiments, applications server 120 may obtain information about actual call flows of a plurality of communication sessions from client 130. For example, client 130 may provide access to information about the actual call flows of a plurality of communication sessions acquired from a third party. As another example, client 130 may provide access to information about the actual call flows of a plurality of communication sessions acquired from another system used by client 130. In certain embodiments, applications server 120 may obtain information about actual call flows of a plurality of communication sessions from web server 128. For example, information about the actual call flows of a plurality of communication sessions may be stored in the cloud and accessed by web server 128.

In certain embodiments, applications server 120 may be configured to send the obtained information to analytics engine 140. In certain embodiments, applications server 120 may be configured to process the obtained information before sending it to analytics engine 140. For example, if the obtained information is an audio recording, applications server 120 may cause the audio recording to be transcribed (e.g., using resource server 124) before sending it to analytics engine 140. As another example, applications server 120 may be configured to annotate and/or supplement the obtained information before sending it to analytics engine 140. Applications server 120 may, for example, append information identifying a speaker and/or add time stamp information. As another example, applications server may append metadata to the obtained information. Nonlimiting examples of metadata include a creation date of an audio recording (or other information pertaining to the actual call flow), an identity of a participant of the associated communication session, a call note made during the associated communication session, identity of the agent, unique call identification information, an indication of which client the call is initiated on behalf of, script data fields, message data, screen recording information, call duration, caller sentiment information, caller angry indication, service enhancement opportunity information, call summary information, agent evaluation scores for the call (e.g., evaluations for answer greeting, attitude, confidence, engagement, grammar, message handling, and/or call outcome), an indication of whether an agent asked the caller to spell their surname, an indication of whether an agent confirmed the caller's phone number, answer time, hold time, an indication of whether an agent politely asked the caller to hold, an indication of whether an agent politely greeted the caller after hold, an indication of whether an agent had control of the call, an indication of whether an agent had proper manners, an indication of whether an agent offered to take a message and to assist caller, and/or an indication of whether an agent politely closed the call and told the caller what actions would be taken.

In certain embodiments, applications server 120 may be configured to send other useful information to analytics engine 140 including any information relevant to the obtained information. In certain embodiments, the applications server 120 may send the obtained information to analytics engine 140 when instructed by client 130. For example, client 130 may run a software application for recovery of a shared baseline script that causes the obtained information to be sent to analytics engine 140. In certain embodiments, applications server 120 waits to send the obtained information to analytics engine 140 until a processing load on analytics engine 140 is low (e.g., during periods of low call volume).

In the example of FIG. 1, analytics engine 140 (via analytics server 141) is coupled to applications server 120 using communications link 145. In certain embodiments, analytics engine 140 receives information about the actual call flows of the communication sessions from applications server 120. In certain embodiments, analytics engine 140 (e.g., via analytics server 141) may use an artificial intelligence model to analyze the information about the actual call flows of the plurality of communication session to recreate a baseline script. In the example embodiment of FIG. 1, media server 142 is coupled to applications server 120, softswitch server 122, and transcription service 143. In certain embodiments, media server 142 may be configured to receive streamed audio or video data for the communication session from softswitch server 122. In certain embodiments, media server 142 receives a stream of audio data from the softswitch server 122 and sends it to transcription service 143 for transcription over communication link 144. When media server 142 receives the transcript from transcription service 143, it may send the transcript to one or more of applications server 120 using communications link 146 and analytics server 141. In certain embodiments, media server 142 may not send data to transcription service 143 and instead processes the data itself. For example, media server 142 may provide a speech recognition engine and voice resources for service platform 106 and analytics engine 140. Media server 142 may include an automatic speech recognition (ASR) engine capable of processing voice responses, natural language processing, text-to-speech translations, and/or speech-to-text translations in connection with one or more voice-enabled functions of service platform 106 and analytics engine 140. For example, media server 142 may convert text to audio and send the audio to softswitch server 122 for playback. As discussed above, in certain embodiments media server 142 may replace resource server 124 and provide similar functionality.

In certain embodiments audio, video, or textual data may transcribed into a meta-language. For example, any of transcription service 143, media server 142, resource server 124, and/or analytics engine 140 may transcribe information about actual call flows of a plurality of communication sessions into a meta-language. In certain embodiments, the metalanguage is in the form of JavaScript Object Notation (“JSON”). In certain embodiments, the recreated shared baseline script (including, for example, the shared baseline script data fields) may be in JSON format. In certain embodiments, transcribing into a meta-language uses less data than a full-text transcription. In certain embodiments, transcribing into a meta-language comprises excluding information as compared to a full-text transcription. For example, extraneous words may be excluded. In certain embodiments, transcribing into a meta-language comprises adding information as compared to a full-text transcription. For example, additional detail such as time stamps, speaker information, and/or other useful information may be added. In certain embodiments, the meta-language comprises symbols representing sentence structure. In certain embodiments, the meta-language comprises symbols representing speaker sentiment. In certain embodiments, the meta-language comprises symbols representing common script elements. In certain embodiments, transcribing the actual call flows of a plurality of communication sessions into a meta-language assists analytics engine 140 in its analysis.

In certain embodiments, analytics engine 140 is configured to analyze the obtained information about the actual call flow of the plurality of communication sessions to generate a script. In certain embodiments, the script is an intelligent script. In certain embodiments, the script is a shared baseline script used in at least some of the actual call flows of the plurality of communication sessions.

In certain embodiments, analytics engine 140 may use an artificial intelligence (“AI”) model, such as, for example, a Large Language Model (“LLM”), to process the information about the actual call flows of the plurality of communication sessions. A LLM is an AI model that can understand human language-based input and generate human-like responses. LLMs advantageously can recognize patterns in a language to generate useful responses.

In the present context, an LLM may be trained on appropriate data in order to generate a model capable of outputting desirable results for generating a shared baseline script. In certain embodiments, the LLM used by analytics engine 140 may be trained on publicly available data. LLMs trained on publicly available data advantageously can leverage large amounts of data for training (in some cases, the larger the training data set is the better results the LLM will provide). In certain embodiments, the LLM may be trained on private data only. Using an LLM trained on, or having access to, private data may advantageously allow for results to be tuned to specific applications and/or use-cases which may provide more accurate results related to those specific applications and/or use-cases. In certain embodiments, the LLM may be trained on a combination of public and private data. This may advantageously combine the benefits of LLMs trained on public and private data. This list is non-exhaustive.

Besides the large language models (LLM) discussed above, other non-limiting examples of artificial intelligence models that may be used by analytics engine 140 may include a linear regression (SLR) model, a naïve bayes model, or a deep neural network (DNN). Analytics engine 140 may use any suitable artificial intelligence model.

In certain embodiments an AI model used by analytics engine 140 is trained on training data consisting of call center scripts and/or information about actual call flows. In certain embodiments, the training data is specific to an industry. In certain embodiments, the training data is specific to a discipline (e.g., sale of products, sale of services, information collection, etc.). In certain embodiments, client 130 may select an AI model (e.g., a LLM) trained on a specific data-set from a set of choices.

In certain embodiments, analytics engine 140 parses the obtained information (e.g., information relating to actual call flows of a plurality of communication sessions) into information segments. In certain embodiments, analytics engine 140 use an AI model to parse the obtained information into information segments. In certain embodiments, analytics engine 140 uses computation techniques to parse the obtained information into information segments. In certain embodiments, applications server 120 parses the obtained information into information segments before sending to analytics engine 140. In certain embodiments, a combination of applications server 120 and analytics engine 140 parses the obtained information into information segments. In certain embodiments, the obtained information is transcribed to text before it is parsed into information segments. In certain embodiments the obtained information is transcribe to a meta-language before it is parsed into information segments.

In certain embodiments, applications server 120 and/or analytics engine 140 provides a prompt to an artificial intelligence model comprising a query and a context window, the context window containing at least some of the obtained information. A query in this context may refer to a request for information or a specific task that the AI model is asked to perform. A query may involve a request to process a sentence, paragraph, or document and return a result based on the AI model's training and capabilities. A context window in this context may refer to the amount of information that the model considers when processing a query. In certain embodiments, analytics engine 140 may prompt an AI model by including a portion of a transcript of a communication session in the context window of the prompt. In certain embodiments, analytics engine 140 may prompt an AI model by including the transcript of a communication session in the context window of the prompt. In certain embodiments, analytics engine 140 may prompt an AI model by including a plurality of transcripts of a plurality of communication sessions in the context window of the prompt. In certain embodiments, the transcript may be made in a meta-language. In certain embodiments, the query portion of the prompt may be to parse the transcript into information segments. In certain embodiments, the query may include a request to use a specific analysis or combination of analyses on the information in the context window to parse the obtained information into information segments. Several nonlimiting examples of types of analyses that may be used for parsing the obtained information are described below.

In certain embodiments, the analytics engine 140 and/or applications server 120 may utilize a lexical analysis to parse the obtained information into information segments. This technique may break down the obtained information into individual words or tokens. In this context, a token may refer to a unit of information that the artificial intelligence model reads, processes, and generates outputs from. A token can be as small as a single character or as long as a word. In certain embodiments, tokens may represent entire phrases. Lexical analysis may allow analytics engine 140 to determine the structure of the text and the roles of individual words or phrases. For example, lexical analysis of a simple sentence such as “The caller stayed on the call” may break the sentence down into individual words or tokens: “The,” “caller,” “stayed,” “on,” “the” and “call.” Each of these tokens may be analyzed by analytics engine 140 for its role in the context of the sentence. For example, “The” and “the” are determiners, “caller” and “call” are nouns, “stayed” is a verb, and “on” is a preposition. In certain embodiments, analytics engine 140 may group multiple words or tokens into information segments based on a lexical analysis.

In certain embodiments, analytics engine 140 and/or applications server 120 may employ a syntactic analysis. This technique analyzes the words or tokens in relation to each other to understand the structure of the text. For example, a syntactic analysis may allow analytics engine 140 to determine the relationships between different words in a sentence, and how these relationships contribute to the meaning of the obtained information. For example, using the example above, syntactic analysis may involve noting that “The caller” is a noun phrase (NP) and “stayed on the call” is a verb phrase (VP). The analysis may further include that verb phrase can be further broken down into “stayed” (a verb, V) and “on the call” (a prepositional phrase, PP). The prepositional phrase may further be broken down into “on” (a preposition, P) and “the call” (another noun phrase, NP). In this way, the structure of the sentence can be represented as follows: Sentence(S)=Noun Phrase (NP)+Verb Phrase (VP), Verb Phrase (VP)=Verb (V)+Prepositional Phrase (PP), Prepositional Phrase (PP)=Preposition (P)+Noun Phrase (NP).

In certain embodiments, analytics engine 140 and/or applications server 120 may employ a semantic analysis. Semantic analysis may go beyond understanding the structure of the text and instead determine the meanings of the words, tokens, and phrases. This may advantageously allow analytics engine 140 to determine the overall meaning of a group of words and group them into an information segment. For example, using the example above, semantic analysis may determine that “The caller” refers to a specific caller,” “stayed” refers to the action of remaining, “on” is a preposition that indicates location, and “the call” refers to a specific call. In certain embodiments, a combination of one or more of these techniques may be used to parse the obtained information into information segments.

In certain embodiments, analytics engine 140 may be configured to determine whether an information segment is part of a shared baseline script. In certain embodiments, analytics engine 140 may determine whether an information segment is part of a shared baseline script based in part on the topic of the information segment. For example, information segments seeking to gather information are more likely to be part of the shared baseline script. In certain embodiments, analytics engine 140 may be configured to determine whether an information segment is part of a shared baseline script based in part on who the speaker is. For example, analytics engine 140 may determine whether an information segment is part of a shared baseline script based in part on whether an agent or caller 102 is speaker. For example, if the caller 102 is speaking the information segment less likely to be part of the shared baseline script because only the agent uses the shared baseline script. In certain embodiments, analytics engine 140 may determine whether an information segment is part of a shared baseline script based in part the frequency of the information segment in the obtained information. For example, if an information segment appears at a high frequency across the plurality of analyzed actual call flows, it is more likely to be part of the shared baseline script. In certain embodiments, applications server 120 and/or analytics engine 140 may provide a prompt to an artificial intelligence model comprising a query asking whether an information segment is part of a shared baseline script. In certain embodiments, the context window of the prompt may include one or more parsed information segments. In certain embodiments, the context window of the prompt may include one or more transcripts of the actual call flows of a plurality of communication sessions. In certain embodiments, the transcripts may be in a meta-language.

In certain embodiments, analytics engine 140 may be configured to determine an order and script branch of an information segment determined to be part of the shared baseline script. In certain embodiments, analytics engine 140 may create a branching “script tree” structure to determine an order and script branch of information segment. In certain embodiments, analytics engine may use the frequency that an information segment appears at a position in the script tree to determine whether a specific order and script branch is appropriate for an information segment. For example, if analytics engine 140 may determine that an order and script branch is appropriate for an information segment if the information segment appears in the same order and script branch greater than a first predefined percentage of the time. The predefined percentage may be, for example, 55%, 60%, 65%, 70%, 75%, 80%, 85%, 90%, 95%, 96%, 97%, 98%, 99%, or 100%. In certain embodiments, if an information segment appears in a specific order and script branch greater than a second predefined percentage, but less that the first predefined percentage, analytics engine 140 may determine that there are multiple different shared baseline scripts used in the obtained information. The second predefined percentage may be 10%, 15%, 20%, 25%, 35%, 40%, 45%, or 50%. In certain embodiments, applications server 120 and/or analytics engine 140 may provide a prompt to an artificial intelligence model comprising a query asking what order and which script branch an information segment is part of in a shared baseline script. In certain embodiments, the context window of the prompt may include one or more parsed information segments determined to be part of a baseline script. In certain embodiments, the context window of the prompt may include one or more transcripts of the actual call flows of a plurality of communication sessions. In certain embodiments, the transcripts may be in a meta-language.

In certain embodiments, the analyzed actual call flows of a plurality of communication sessions may use multiple shared baseline scripts. In certain embodiments, in addition to the functionality described above, analytics engine 140 may be configured to determine whether the analyzed actual call flows of a plurality of communication sessions use multiple shared baseline scripts. In certain embodiments, analytics engine 140 is configured to determine which of multiple shared baseline scripts an information segment belongs. In certain embodiments, applications server 120 and/or analytics engine 140 may provide a prompt to an artificial intelligence model comprising a query asking to which shared baseline script an information segment belongs. In certain embodiments, analytics engine 140 may be configured to recreate multiple shared baseline scripts. In certain embodiments, the recreating of the multiple shared baseline scripts may occur substantially concurrently.

In addition to recreating a shared baseline script, it may be desirable to create an evaluation script based on the actual call flows of a plurality of communication sessions. In certain embodiments, analytics engine 140 may be configured to generate an evaluation script. In certain embodiments, an evaluation script may comprise questions or other parameters for evaluating a performance of an agent using a shared baseline script. In certain embodiments, analytics engine 140 may associate certain questions or metrics with one or more specific information segments that make up the shared baseline script. For example, an information segment of the shared baseline script may be greeting. Analytics engine 140 may generate, as part of an evaluation script, a question associated with the information segment such as “Did the agent greet the customer with an appropriate greeting?”. As another example, analytics engine 140 may generate a parameter associated with the same information segment such as “friendliness.” The parameter may have an assignable value, for example, a number between 1 and 10. In certain embodiments, analytics engine 140 may generate one or more questions or parameters associated with each information segment comprising the shared baseline script. A nonlimiting list of topics for questions and/or parameters may include accuracy to script, accuracy of agent's notes, attitude of agent, confidence level of an agent, whether the agent asked for appropriate information, whether the agent used proper grammar, whether the agent maintained a positive caller sentiment for the call, whether the agent allowed the caller to become angry during the call, whether the agent took advantage of any service enhancement opportunities for the call, whether the agent used an appropriate answer and/or greeting, whether the agent used an appropriate attitude, the level to which the agent engaged with the caller, whether the agent confirmed spelling of caller's surname, whether the agent confirmed caller's phone number, whether the agent offered to take a message, whether the agent placed caller on hold, whether the agent kept the caller on hold for an appropriate amount of time, whether the agent politely asked the caller if they could place them on hold before doing so, whether the agent politely greeted the caller after the hold, whether the agent politely closed/completed the call, and/or whether the agent informed the caller of follow up actions while closing the call. Other topics for questions and/or parameters are possible. In certain embodiments, applications server 120 and/or analytics engine 140 may provide a prompt to an artificial intelligence model comprising a query asking questions and/or parameters should be generated for one or more information segments. In certain embodiments, the context window of the prompt may include one or more parsed information segments. In certain embodiments, the context window of the prompt may include one or more transcripts of the actual call flows of a plurality of communication sessions. In certain embodiments, the transcripts may be in a meta-language. In certain embodiments, analytics engine 140 generates a predefined number of questions and/or parameters for each information segment. For example, analytics engine 140 may generate 1, 2, 3, 4, 5, 6, 7, 8, 9, or 10 questions and/or parameters for each information segment. In certain embodiments, some questions or parameters may be repeated for all information segments comprising the shared baseline script used by the agent. In certain embodiments, some information segments may not have a question and/or parameter generated because the information segment will not be evaluated.

In certain embodiments, the generated questions and/or parameters are synced together according to the relative order and branches of their associated information segments. For example, in the case where each information segment has associated questions and/or parameters generated for the evaluation script, the questions and/or parameters may likewise be grouped in the same order and branches to create a preliminary evaluation script. In certain embodiments, the preliminary evaluation script may be created in a “script tree” format.

In certain embodiments, the preliminary evaluation script is purged of extraneous questions and/or parameters using analytics engine 140. This may advantageously allow for the evaluation script to focus only on evaluating key parts of the baseline script that are likely to have the largest impact on the client 130's desired outcome and streamline the evaluation. In certain embodiments, analytics engine 140 purges a predefined number of questions and/or parameters. For example, analytics engine may purge 1, 2, 3, 4, 5, 6, 7, 8, 9, or 10 questions and/or parameters from the preliminary evaluation script. In certain embodiments, analytics engine 140 purges questions and/or parameters until the total number of questions and/or parameters is under a predefined threshold for the evaluation script as a whole. In certain embodiments, analytics engine 140 purges a predefined percentage of questions and/or parameters form the preliminary evaluation script. In certain embodiments, no generated questions and/or parameters are purged. This embodiment may be particularly useful when applications server 120 and/or analytics engine 140 is used to evaluate the agent rather than a manual evaluation process. In certain embodiments, applications server 120 and/or analytics engine 140 may evaluate an actual call flow of a communication session according to the evaluation script. In certain embodiments, applications server 120 and/or analytics engine 140 may provide a prompt to an artificial intelligence model comprising a query where the query is a question or parameter of an evaluation script associated with an information's segment. In certain embodiments, the context window of the prompt may include one or more parsed information segments determined to be part of a baseline script. In certain embodiments, the context window of the prompt may include one or more transcripts of the actual call flows of a plurality of communication sessions. In certain embodiments, the transcripts may be in a meta-language. In certain embodiments, a supervisor or reviewer may evaluate the agent using the evaluation script.

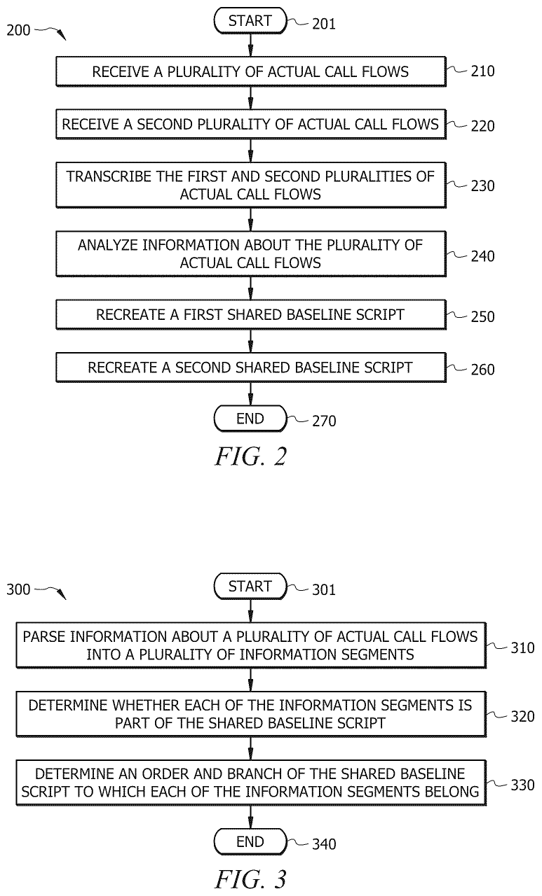

FIG. 2 is a flow diagram of an exemplary method 200, in accordance with certain embodiments. In certain embodiments, the method may be performed by a call-center service platform (e.g., service platform 106 described above in relation to FIG. 1) and/or an analytics engine (e.g., analytics engine 140 described above in relation to FIG. 1). The method begins at step 201.

At step 210, a plurality of actual call flows is received. In certain embodiments, the plurality of actual call flows is a first plurality of actual call flows. In certain embodiments, the plurality of actual call flows may comprise audio recordings. In certain embodiments, the plurality of actual call flows may be text-based. In certain embodiments, the plurality of actual call flows may be video recordings. As described with respect to FIG. 1, in certain embodiments, applications server 120 may monitor actual call flows of a plurality of communication sessions. In certain embodiments a legacy system may monitor and/or record actual call flows of a plurality of communication sessions. In certain embodiments, a client (e.g., client 130) may provide the plurality of actual call flows. In certain embodiments, the actual call flows may be purchased or acquired from a third-party. In certain embodiments, the plurality of call flows may use a shared baseline script.

At step 220, a second plurality of actual call flows is received. In certain embodiments, the second plurality of actual call flows may be text-based. In certain embodiments, the plurality of actual call flows may be video recordings. In certain embodiments, the second plurality of actual call flows may comprise audio recordings. In certain embodiments, application server 120 may monitor a plurality of actual call flows in real time. As described with respect to FIG. 1, in certain embodiments, applications server 120 may monitor actual call flows of a plurality of communication sessions. In certain embodiments a legacy system may monitor and/or record actual call flows of a plurality of communication sessions. In certain embodiments, a client (e.g., client 130) may provide the plurality of actual call flows. In certain embodiments, the actual call flows may be purchased or acquired from a third-party. In certain embodiments, the second plurality of call flows use a shared baseline script. In certain embodiments the first plurality of actual call flows may use a shared baseline script that is different than a shared baseline script used by the second plurality of actual call flows.

At step 230, the first and second pluralities of actual call flows are transcribed. In certain embodiments, this step may be performed by one or more of transcription service 143, media server 142, resource server 124, and/or analytics engine 140. As described above with respect to FIG. 1, the transcription may use a meta-language format. In certain embodiments, the first and second pluralities of actual call flows are not transcribed if they are already in a useable format.

At step 240, the first and second pluralities of actual call flows are analyzed. More detail on the analysis is included with respect to FIG. 3 and above with respect to FIG. 1.

At step 250, the first shared baseline script is recreated. At step 260, the second shared baseline script is recreated. More detail on recreating a baseline script is included above with respect to FIG. 1. In certain embodiments, the first and second baseline scripts may be provided in “script tree” format. In certain embodiments, the first and second baseline scripts may comprise text, images, informational graphics, video, and/or other multimedia content. In certain embodiments, the recreated baseline script may be written in JSON format. At step 270, the method ends.

FIG. 3 is a flow diagram of an exemplary method 300, in accordance with certain embodiments. In certain embodiments, the method may be performed by a call-center service platform (e.g., service platform 106 described above in relation to FIG. 1) and/or an analytics engine (e.g., analytics engine 140 described above in relation to FIG. 1). The method begins at step 301.

At step 310, information about first and second pluralities of actual call flows are parsed into a plurality of information segments. More detail about parsing the actual call flows into information segments is described above with respect to FIG. 1. In certain embodiments, an artificial intelligence model (e.g., an artificial intelligence model included in analytics engine 140) is prompted to parse the actual call flows into information segments.

At step 320, it is determined whether each of the information segments is part of a baseline script. More detail on determining whether each information segment is part of a baseline script is described above with respect to FIG. 1. In certain embodiments, an artificial intelligence model is prompted to determine whether each information segment is part of a baseline script (e.g., an artificial intelligence model included in analytics engine 140).

At step 330, it is determined what order and branch of the baseline script the information segments belong. More detail on determining what order and branch of the baseline script the information segments belong is described above with respect to FIG. 1. In certain embodiments, an artificial intelligence model is prompted to determine what order and branch of the baseline script the information segments belong (e.g., an artificial intelligence model included in analytics engine 140). At step 340, the method ends.

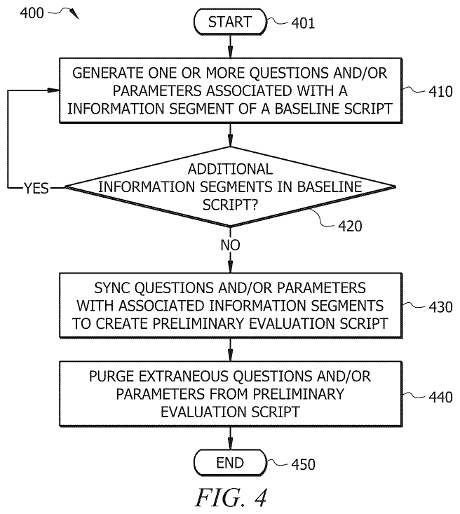

FIG. 4 is a flow diagram of an exemplary method 400, in accordance with certain embodiments. In certain embodiments, the method may be performed by a call-center service platform (e.g., service platform 106 described above in relation to FIG. 1) and/or an analytics engine (e.g., analytics engine 140 described above in relation to FIG. 1). The method begins at step 401.

At step 410, one or more questions and/or parameters are generated in association with an information segment of a baseline script. More detail on generating questions and/or parameters for an information segment of a baseline script is included above with respect to FIG. 1.

At step 420, it is determined whether there are additional information segments in the baseline script for which to generate one or more questions and/or parameters. If there are additional information segments, step 420 returns to step 410. If there are no additional information segments, then step 420 moves on to step 430. In certain embodiments, some information segments included in the baseline script may not need to be evaluated and step 420 may move on to step 430 without generating one or more questions and/or parameters for those information segments.

At step 430, the generated questions and/or parameters are synced to their associated information segments to create a preliminary evaluation script. More detail on creating the preliminary evaluation script is included above with respect to FIG. 1. In certain embodiments, the preliminary evaluation script may be provided in “script tree” format.

At step 440, extraneous questions and/or parameters are purged from the preliminary evaluation script. More detail on purging the preliminary evaluation script is included above with respect to FIG. 1. At step 450, the method ends.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components.

Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A system, the system comprising:
an applications server communicatively coupled to an analytics engine, wherein:
the applications server is configured to:
receive a plurality of actual call flows, each of the plurality of actual call flows associated with a respective communication session, each of the respective communication sessions utilizing a shared baseline script; and
send information about the plurality of actual call flows to the analytics engine; and
the analytics engine is configured to:
analyze the information about the plurality of actual call flows by parsing the information into a plurality of information segments, determining whether each of the information segments is part of the shared baseline script, and, for the information segments determined to be part of the shared baseline script, determining an order and branch of the shared baseline script to which each of the information segments belong; and recreate, using the analysis, the shared baseline script.

2. The system of claim 1, wherein the plurality of actual call flows comprises an audio recording of each of the plurality of communication sessions.

3. The system of claim 2, wherein the applications server is further configured to transcribe the received audio recordings of each of the plurality of communication sessions and wherein the information sent to the analytics engine comprises a transcription of each audio recording.

4. The system of claim 3, wherein the transcription of each audio recording uses a meta-language and wherein the transcription of the received audio recordings using the meta-language requires less data than a full-text transcription.

5. The system of claim 2, wherein each of the plurality of actual call flows further comprise metadata and wherein the metadata includes at least one of: a creation date of the audio recording, an identity of a participant of the associated communication session, and a call note made during the associated communication session.

6. The system of claim 1, wherein the plurality of actual call flows is a first plurality of actual call flows, wherein the shared baseline script is a first shared baseline script, and wherein the applications server is further configured to:
receive a second plurality of actual call flows, each of the second plurality of actual call flows associated with a respective communication session, each of the respective communication sessions associated with the second plurality of actual call flows utilizing a second shared baseline script; and
send information about the second plurality of actual call flows to the analytics engine; and
wherein the analytics engine is further configured to:
analyze the information about the second plurality of actual call flows by parsing the information into the plurality of information segments, determining whether each information segment is part of the second shared baseline script, and, for information segments determined to be part of the second shared baseline script, determining an order and branch of the second shared baseline script to which each of the information segments belong; and
recreate, based on the analysis of the second plurality of actual call flows, the second shared baseline script.

7. The system of claim 6, wherein the analysis of the information about the first plurality of actual call flows and the analysis of the information about the second plurality of actual call flows occurs concurrently.

8. A method, the method comprising:
receiving a plurality of actual call flows, each of the plurality of actual call flows associated with a respective communication session, each of the respective communication sessions utilizing a shared baseline script;
analyzing information about the plurality of actual call flows by parsing the information into a plurality of information segments, determining whether each of the information segments is part of the shared baseline script, and, for the information segments determined to be part of the shared baseline script, determining an order and branch of the shared baseline script to which each of the information segments belong; and
recreating, using the analysis, the shared baseline script.

9. The method of claim 8, wherein the plurality of actual call flows comprises an audio recording of each of the plurality of communication sessions.

10. The method of claim 9, wherein the method further comprises transcribing the received audio recordings of each of the plurality of communication sessions and wherein the information comprises a transcription of each audio recording.

11. The method of claim 10, wherein the transcription of each audio recording uses a meta-language and wherein the transcription of the received audio recordings using the meta-language requires less data than a full-text transcription.

12. The method of claim 9, wherein each of the plurality of actual call flows further comprises metadata and wherein the metadata includes at least one of: a creation date of the audio recording, an identity of a participant of the associated communication session, and a call note made during the associated communication session.

13. The method of claim 9, wherein the plurality of actual call flows is a first plurality of actual call flows, wherein the shared baseline script is a first shared baseline script, and wherein the method further comprises:
receiving a second plurality of actual call flows, each of the second plurality of actual call flows associated with a respective communication session, each of the respective communication sessions associated with the second plurality of actual call flows utilizing a second shared baseline script;
analyzing the information about the second plurality of actual call flows by parsing the information into the plurality of information segments, determining whether each information segment is part of the second shared baseline script, and, for information segments determined to be part of the second shared baseline script, determining an order and branch of the second shared baseline script to which each of the information segments belong; and
recreating, based on the analysis of the second plurality of actual call flows, the second shared baseline script.

14. The method of claim 13, wherein the analysis of the information about the first plurality of actual call flows and the analysis of the information about the second plurality of actual call flows occurs concurrently.

15. A non-transitory computer-readable medium may have stored therein a program, the program configured when executed to:
receive a plurality of actual call flows, each of the plurality of actual call flows associated with a respective communication session, each of the respective communication sessions utilizing a shared baseline script;
analyze the information about the plurality of actual call flows by parsing the information into a plurality of information segments, determining whether each of the information segments is part of the shared baseline script, and, for the information segments determined to be part of the shared baseline script, determining an order and branch of the shared baseline script to which each of the information segments belong; and
recreate, using the analysis, the shared baseline script.

16. The non-transitory computer-readable medium of claim 15, wherein the plurality of actual call flows comprises an audio recording of each of the plurality of communication sessions.

17. The non-transitory computer-readable medium of claim 16, wherein the program is further configured when executed to transcribe the received audio recordings of each of the plurality of communication sessions and wherein the information comprises a transcription of each audio recording.

18. The non-transitory computer-readable medium of claim 17, wherein the transcription of each audio recording uses a meta-language and wherein the transcription of the received audio recordings using the meta-language requires less data than a full-text transcription.

19. The non-transitory computer-readable medium of claim 15, wherein each of the plurality of actual call flows further comprises metadata and wherein the metadata includes at least one of: a creation date of the audio recording, an identity of a participant of the associated communication session, and a call note made during the associated communication session.

20. The non-transitory computer-readable medium of claim 15, wherein the plurality of actual call flows is a first plurality of actual call flows, wherein the shared baseline script is a first shared baseline script, wherein the program is further configured when executed to:
receive a second plurality of actual call flows, each of the second plurality of actual call flows associated with a respective communication session, each of the respective communication sessions associated with the second plurality of actual call flows utilizing a second shared baseline script;
analyze the information about the second plurality of actual call flows by parsing the information into plurality of information segments, determining whether each information segment is part of the second shared baseline script, and, for information segments determined to be part of the second shared baseline script, determining an order and branch of the second shared baseline script to which each of the information segments belongs;
recreate, based on the analysis of the second plurality of actual call flows, the second shared baseline script; and
wherein the analysis of the information about the first plurality of actual call flows and the analysis of the information about the second plurality of actual call flows occurs concurrently.
